(19) United States
(12) Patent Application Publication
(10) Pub. No.: US 2010/0303096 A1
(43) Pub. Date: Dec. 2, 2010

(54) Apparatus and mehtods for increased mac header protection

(76) Inventors: Assaf Kasher, Haifa (IL); Ilan Sutskover, Hadera (IL); Solomon Trainin, Haifa (IL)

Correspondence Address: INTEL CORPORATION;c/o CPA Global, P.O. BOX 52050, MINNEAPOLIS, MN, 55402, US

(21) Appl. No.: 12/455,538

(22) Filed: Jun. 2, 2009

(51) Int. Cl. H04J 3/24

(52) U.S. Cl. 370/474

(57) ABSTRACT

Embodiments of systems and methods for increased media access control (MAC) header protection are generally described herein. Other embodiments may be described and claimed.

### TECHNICAL FIELD

The present disclosure relates generally to the field of wireless communications and more particularly to systems and related methods of providing a robust communications protocol in a wireless environment.

### BACKGROUND

Wireless access networks can be used for transmitting content, as provided by television broadcasts and the Internet. The need to transfer multimedia or high throughput data streams between devices in wireless access networks requires reception of a robust data stream at a high data rate. Beamforming and beamtracking methods and systems may be used to achieve the high transmission rates needed for video streaming and other applications in a wireless environment. As the wireless environment changes, a signal to noise ratio measured at the receiver can deteriorate, leading to a loss or corruption of address information and/or associated data.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating devices using signals to communicate in a wireless network in accordance with some embodiments of the invention;

FIG. 2 is a block diagram of a component in accordance with some embodiments of the invention;

FIG. 3 is a block diagram of a packet with a medium access control (MAC) header coded at an intermediate modulation and coding scheme in accordance with some embodiments of the invention;

FIG. 4 is a block diagram of a packet with a MAC header combined with parity bits in a payload of a packet in accordance with some embodiments of the invention;

FIG. 5 is a flow diagram of a method to increase robustness of a wireless communication in accordance with some embodiments of the invention; and

FIG. 6 is an alternate flow diagram of a method to increase robustness of a wireless communication in accordance with some embodiments of the invention.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details for providing methods to increase media access control (MAC) header protection are set forth to provide a thorough understanding of the invention. However, it will be understood by those skilled in the art that the present invention may be practiced without these specific details. In other instances, well-known methods, procedures, components and circuits have not been described in detail so as not to obscure the present invention.

It would be an advance in the art to provide robust methods for wireless transmission of packets by increasing a probability that a receiver will capture beamforming information intended for the receiver. Some wireless communication links benefit from the use of beamforming techniques to achieve high data rates needed to support video streaming and other high throughput applications. Environmental changes in a wireless network, such as movement of the transmitter and/or receiver or changes in reflectors in their vicinity may cause changes in the wireless channel and lead to an increase in signal to noise ratio (SNR).

Packet information, including receiver address information intended for a receiving device may be lost during a wireless exchange. If the receiving device does not know that a packet was directed at the receiving device, then it does not know to initiate a beamtracking sequence for reception of the packet. To provide a more robust wireless communications link, addressing information in the form of a MAC header may be transmitted using a modulation and coding scheme (MCS) that differs from a MCS used for data transmission. Alternately or in combination, the MAC header may be passed through a forward error correction (FEC) scheme if the MAC header is transmitted using the MCS used for data transmission. Further, destination identification (ID) information in a full or truncated form may be inserted in a PHY header. A result is that one or more packets in the wireless communication may be transferred more quickly or efficiently while preserving MAC header information during the exchange.

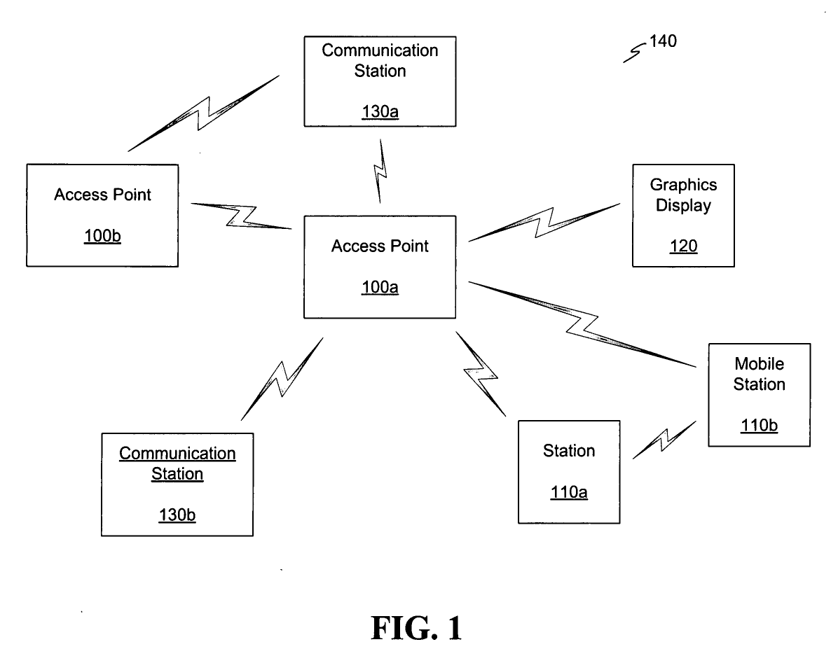

Now turning to the figures, FIG. 1 illustrates a block diagram of devices transmitting and receiving signals to communicate in a network, such as 60 GHz band ((57-66 GHz) millimeter-wave (mm-wave)) communications network. Some embodiments of the invention may be used in conjunction with various devices and systems, for example a wireless communication station, a station, a client, a wireless communication device, a wireless Access Point (AP), a modem, a wireless modem, a Personal Computer (PC), a desktop computer, a mobile computer, a laptop computer, a notebook computer, a tablet computer, a server computer, a set-top box, a handheld computer, a handheld device, a Personal Digital Assistant (PDA) device, a handheld PDA device, a station, a mobile station (MS), a graphics display, and a communication station.

Alternately or in combination, the devices can also use signals to communicate in a wireless network such as a Local Area Network (LAN), a Wireless LAN (WLAN), a Metropolitan Area Network (MAN), a Wireless MAN (WMAN), a Wide Area Network (WAN), a Wireless WAN (WWAN), devices and/or networks operating in accordance with existing Next Generation mmWave (NGmS-D02/r0, Nov. 28, 2008), Wireless Gigabit Alliance (WGA), IEEE 802.11, 802.11a, 802.11b, 802.11e, 802.11g, 802.11h, 802.11i, 802.11n, 802.16, 802.16d, 802.16e standards and/or future versions and/or derivatives and/or Long Term Evolution (LTE) of the above standards, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, a Multiple Input Multiple Output (MIMO) transceiver or device, a Single Input Multiple Output (SIMO) transceiver or device, a Multiple Input Single Output (MISO) transceiver or device, a Maximum Ratio Combining (MRC) transceiver or device, a transceiver or device having “smart antenna” technology or multiple antenna technology, or the like.

Some embodiments of the invention may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), Extended GPRS, Code-Division Multiple Access (CDMA), Wideband CDMA (WCDMA), CDMA 2000, Multi-Carrier Modulation (MDM), Discrete Multi-Tone (DMT), Bluetooth®, ZigBee™, or the like. Embodiments of the invention may be used in various other apparatuses, devices, systems and/or networks.

A network 140 may comprise a plurality of nodes or devices, such as access points (100a & 100b), a station 110a, a mobile station 110b, a graphics display (120) and communication stations (130a & 130b). Access point 100a may communicate with another access point 100b and communication stations, such as communication stations (CS) 130a and 130b. The CSs 130a and 130b may be fixed or substantially fixed devices. In some embodiments, the devices may use millimeter-wave signals for communicating in a PAN, although the scope of the invention is not limited in this respect.

Access point 100a may also communicate with other devices such as station 110a and graphics display 120. In some embodiments, access point 100a and station 110a operate as part of a peer-to-peer (P2P) network. In other embodiments access point 100a and station 110a operate as part of a mesh network, in which communications may include packets routed on behalf of other wireless devices of the mesh network, such as mobile station 110b. Fixed wireless access, wireless local area networks, wireless personal area networks, portable multimedia streaming, and localized networks such as an in-vehicle networks, are some examples of applicable P2P and mesh networks.

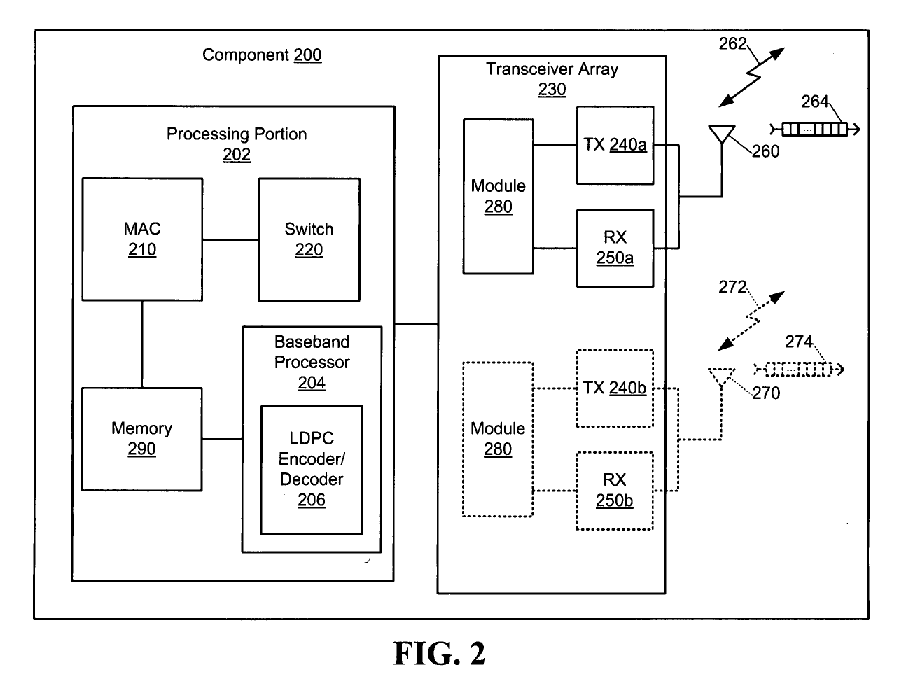

Accordingly, in one embodiment, network 140 may comprise component 200, as illustrated in FIG. 2, in one or more devices such as 100a, 110a, 110b, 120, and 130b to implement techniques to provide communications devices that support one or more standards to improve overall performance in devices such as 100a, 110a, 110b, 120, and 130b and to increase overall network 140 performance. Component 200 may comprise a module 206 depending on the particular embodiment thereof. In one embodiment, module 206 may comprise a low-density parity-check (LDPC) encoder/decoder to encode/decode a variety of codes in a single transceiver (e.g., or a transmitter and receiver). Telecommunications systems apply LDPC codes to provide error correction capability. In many telecommunications error correction applications, a LDPC decoder may be used to decode a variety of codes in a single receiver.

LDPC codes are a type of FEC block codes which are constructed using a number of simple parity-check relationships shared between the bits in a codeword. An LDPC code (n, k) where n is the codeword length and k is the information length, is usually represented by a sparse parity-check matrix H with dimension n*(n−k). The parity check matrix is used as a basis for encoding and decoding LDPC codewords. The LDPC encoder/decoder may be implemented either as a Digital Signal Processor (DSP) or an Application Specific Integrated Circuit (ASIC). Embodiments of module 206 comprising a LDPC encoder/decoder implemented as a DSP may provide a flexible solution although the speed that it can operate at may be limited by power constraints, for example. Embodiments of module 206 comprising an encoder/decoder implemented as an ASIC may operate at higher speeds although it may not provide the same flexibility as a DSP implementation because it is “hard-wired” and, accordingly, may be difficult to reconfigure once it has been built. Embodiments of module 206 comprising a LDPC encoder/decoder may be programmed for decoding multiple codes such as LDPC or other FEC codes by downloading new programming into the address generator modules of the decoder. Further, a LDPC encoder/decoder may be programmed for new protocols, thus enabling it to be more widely used across telecommunications products with less time-to-market. Moreover, embodiments of a LDPC encoder/decoder reduces the complex routing between check and symbol nodes, thus simplifying its implementation.

In one embodiment, wireless devices such as 100a, 110a, 110b, 120, and 130b communicate over wireless links. The wireless links between these wireless devices may experience noise and/or various interference effects that can compromise communication quality. To overcome these limitations, a FEC code may be used. That is, a FEC coder may be provided within a transmitting device, e.g., module 206 of component 200, to encode data before it is wirelessly transmitted. When the signal is received, a FEC decoder within a receiving device, e.g., module 206 of component 200, may be used to decode the signal. The FEC decoder is capable of detecting and correcting one or more errors in the received data. In this manner, errors caused by noise and/or interference effects in a channel 262 may be overcome. In one embodiment, a LDPC code may be used as the FEC code within a wireless device such as devices 100a, 110a, 110b, 120, and 130a.

FIG. 2 illustrates one embodiment of a component 200. FIG. 2 may illustrate a block diagram for component 200 of network 140, for example. Component 200 may be implemented as part of the wireless devices as described with reference to FIG. 1. As shown in FIG. 2, component 200 may comprise a processing portion 202 and a transceiver array 230 portion. Processing portion 202 may comprise multiple elements of the PHY layer, such as baseband processor 204 comprising a LDPC encoder/decoder 206, medium access controller (MAC) 210, switch (SW) 220, and memory 290. Some elements may be implemented using, for example, one or more circuits, components, registers, processors, software routines, or any combination thereof. Although FIG. 2 shows a limited number of elements, it can be appreciated that additional or fewer elements may be used in component 200 as desired for a given implementation. The embodiments are not limited in this context.

In one embodiment, component 200 may include transceiver array 230. Transceiver array 230 may comprise multiple transmitter 240a, b and receiver 250a, b pairs. In one embodiment, each transmitter 240a, b and receiver 250a, b pair may comprise module 280 based on the specific embodiments thereof. In one embodiment, module 280 may be an amplifier. Transceiver array 230 may be implemented as, for example, a MIMO system. MIMO system 230 may include two transmitters 240a and 240b, and two receivers 250a and 250b. Although MIMO system 230 is shown with a limited number of transmitters and receivers, it may be appreciated that transceiver array 230 may include any desired number of transmitters and receivers. The embodiments are not limited in this context.

In one embodiment, transmitters 240a, b and receivers 250a, b of transceiver array 230 may be implemented as OFDM transmitters and receivers. Transmitters 240a, b and receivers 250a, b may communicate packets 264, 274, respectively, with the other wireless devices over channels 262, 272, respectively. For example, when implemented as part of access point 110a or access point 110b, transmitters 240a, b and receivers 250a, b may communicate packets 264, 274 with station 110a. When implemented as part of station 110a, transmitters 240a, b and receivers 250a, b may communicate packets 264, 274 with access point 110a or access point 110b. The packets may be modulated in accordance with one or more modulation schemes, to include Binary Phase Shift Keying (BPSK), Quadrature Phase-Shift Keying (QPSK), Quadrature Amplitude Modulation (QAM), 16-QAM, 64-QAM, and so forth. The embodiments are not limited in this context.

In one embodiment, transmitter 240a and receiver 250a may be operably coupled to an antenna 260, and transmitter 240b and receiver 250b may be operably coupled to antenna 270. Examples for antenna 260 and/or antenna 270 may include an internal antenna, an omni-directional antenna, a monopole antenna, a dipole antenna, an end fed antenna, a circularly polarized antenna, a micro-strip antenna, a diversity antenna, a dual antenna, an antenna array, a helical antenna, and so forth. In one embodiment, network 140 may be implemented as a MIMO based WLAN comprising multiple antennas to increase throughput and may trade off increased range for increased throughput. MIMO-based technologies may be applied to other wireless technologies as well. Although the network 140 may be implemented as a WPAN such as 60 GHz band ((57-66 GHz) millimeter-wave (mm-wave) or a WLAN in accordance with 802.11a/b/g/n protocols for wireless access in an enterprise, other embodiments in use in the enterprise may include reconfigurable radio technologies and/or multiple radios (e.g., multiple transceivers, transmitters, and/or receivers), for example. The embodiments are not limited in this context.

Processing portion 202 may be configured to perform digital communication functions such as a medium access control (MAC) 210 and/or baseband processing using baseband processor 204. In one example implementation, an LDPC encoder/decoder 206 configured to perform an encoding method is integrated, along with an optional digital demodulator (not separately shown), as part of digital baseband processor 204. The embodiments are however not limited in this respect. Additional elements, such as one or more analog to digital converters (ADC), digital to analog converters (DAC), a memory controller, a digital modulator and/or other associated elements, may also be included as part of component 200.

The baseband processor 204 and the MAC 210 may be implemented in hardware as general purpose processors. For example, baseband processor 204 and the MAC 210 may comprise a general purpose processor made by Intel® Corporation, Santa Clara, Calif. Baseband processor 204 and the MAC 210 also may comprise a dedicated processor, such as a controller, microcontroller, embedded processor, a digital signal processor (DSP), a network processor, an input/output (I/O) processor, a media processor, and so forth. The baseband processor 204 and the MAC 210 may include baseband and applications processing functions and utilize one or more processor cores and/or firmware and hardware in an Application Specific Integrated Circuit (ASIC) device. For example, the baseband processor 204 and the MAC 210 may provide functions that fetch instructions, generate decodes, find operands, and perform appropriate actions, then store results.

The baseband processor 204 and the MAC 210 may be combined as a single device with multiple cores. The use of multiple cores may allow one core to be dedicated to MAC layer functions while another core is dedicated to baseband functions. Alternatively, the multiple cores may allow processing workloads to be shared across the cores. It may be desirable for the MAC 210 and the baseband processor 204 processors to be embodied in hardware because as data rates increase, a software embodied processor such as the MAC 210 and/or the baseband processor 204 may not be fast enough to process the data in high throughput applications.

In one embodiment, component 200 may include a memory 290. Memory 290 may comprise any machine-readable or computer-readable media capable of storing data, including both volatile and non-volatile memory. For example, the memory may comprise read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. The embodiments are not limited in this context.

In one embodiment, wireless devices 100a, 110a, 110b, 120, and 130a of network 140 may operate in accordance with one or more of the IEEE 802.11 and or the Wireless Gigabit Alliance (WGA) series of specifications. A wireless device operating in accordance with an IEEE 802.11 specification may require the implementation of at least two layers. One layer is the 802.11 MAC layer (i.e., OSI Data/Link Layer 2). In general, the MAC layer manages and maintains communications between 802.11 and/or mmWave devices by coordinating access to a shared radio channel. For example, the MAC layer may perform such operations as scanning for 802.11 devices, authenticating 802.11 devices, associating an AP with a STA, performing security techniques such as wireless encryption protocol (WEP), request to send (RTS) and clear to send (CTS) operations, power saving operations, fragmentation operations, and so forth. Another layer is the 802.11 PHY layer (i.e., OSI Physical Layer 1). The PHY layer may perform the operations of carrier sensing, transmission, and receiving of 802.11 frames in one embodiment. For example, the PHY layer may integrate operations such as modulation, demodulation, encoding, decoding, analog-to-digital conversion, digital-to-analog conversion, filtering, and so forth. The PHY layer may be implemented using dedicated hardware or through software emulation. The MAC layer may be implemented using either or a combination of dedicated hardware and dedicated software.

In one embodiment, MAC 210 may be arranged to perform MAC layer operations. For example, MAC 210 may be implemented as a media access controller in hardware or software form to perform MAC layer processing operations. In addition, MAC 210 may be arranged to select a data rate to communicate media and control information between wireless devices over wireless shared media 160 in accordance with one or more WLAN protocols, such as the IEEE 802.11n proposed standard, for example. The embodiments, however, are not limited in this context.

When implemented in a device of network 140, component 200 may be arranged to communicate information between the various nodes, such as access point 110a, access point 110b, and station 110a. The information may be communicated in the form of packets 264, 274 over channels 262, 272 established, with each packet 264, 274 comprising media information and/or control information. The media and/or control information may be represented using, for example, multiple OFDM symbols. Packets 264, 274 may be part of a frame, which in this context may refer to any discrete set of information, including a unit, packet, cell, segment, fragment, and so forth. The frame may be of any size suitable for a given implementation. Typical WLAN protocols use frames of several hundred bytes, and an 802.11 frame may have a length of up to 1518 bytes or more, for example. In one embodiment, devices of network 140 and component 200 may be arranged to communicate information between the various nodes, such as access point 110a, access point 110b, and station 110a. Although embodiments describe communication of information in the form of packets 264, 274 over wireless channels 262, 272, the embodiments are not limited in this context.

When implemented as part of station 110a, MAC 210 may be arranged to associate with an access point 100a and/or 100b. For example, MAC 210 may passively scan for access points, such as access point 100a and/or 100b. Access point 100a and/or 100b may periodically broadcast a beacon. The beacon may contain information about the access point including a service set identifier (SSID), supported data rates, and so forth. MAC 210 may use this information and the received signal strength for each beacon to compare AP and decide upon which one to use. Alternatively, MAC 210 may perform active scanning by broadcasting a probe frame, and receiving probe responses from access point 100a and/or 100b. Once an AP has been selected, MAC 210 may perform authentication operations to prove the identity of the selected AP. Authentication operations may be accomplished using authentication request frames and authentication response frames. Once authenticated, station 110a associates with the selected access point before sending packets. Association may assist in synchronizing station 110a and the access point 100a with certain information, such as supported data rates. Association operations may be accomplished using association request frames and association response frames containing elements such as SSID and supported data rates. Once association operations are completed, station 110a and access point 100a can send packets to each other, although the embodiments are not limited in this regard.

In some embodiments, MAC 210 also may be arranged to select a data rate to communicate packets based on current channel 262, 272 conditions. For example, assume station 110a associates with a peer, such as an access point 100a or other wireless device (e.g., mobile station 110b). Station 110a may be arranged to perform receiver directed rate selection. Consequently, station 110a may need to select one or more data rates to communicate packets 264, 274 between station 110a and access point 100b prior to communicating the packets 264, 274.

While the following detailed description references example implementations in relation to LDPC codes, the embodiments are not necessarily limited thereto and may be applied to other coding/decoding schemes where suitably appropriate. LDPC codes are a form of error correction codes similar to Turbo codes, but much more computationally intensive with the advantage that they can achieve near Shannon-limit communication channel capacity. An LDPC code is a linear message encoding technique defined by a sparse parity check matrix. The message to be sent is encoded using a generator matrix or the sparse parity check matrix and when it reaches its destination, it is decoded using the sparse parity check matrix.

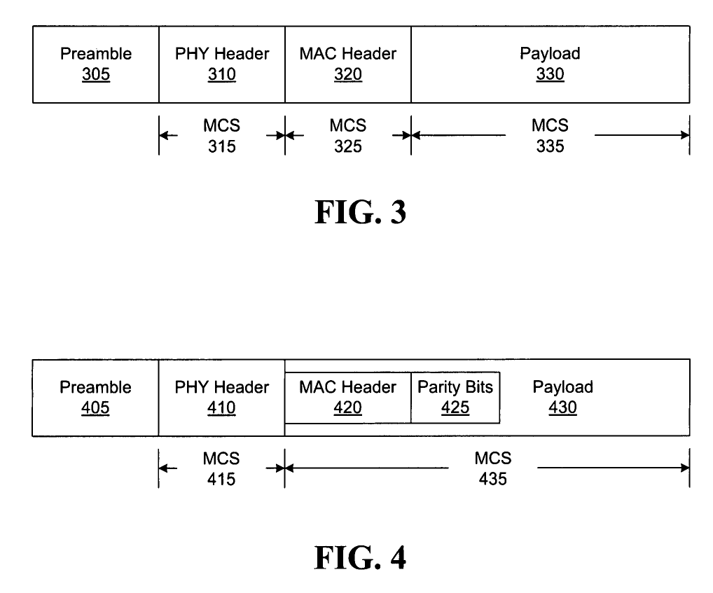

FIG. 3 is a block diagram of the packet 264 and/or 274 of FIG. 2 having a preamble 305, a PHY header 310, a MAC header 320, and a payload 330. In one embodiment, the preamble 305 is provided for packet detection and/or PHY synchronization while the PHY header 310 may indicate the MCS used for the payload along with other PHY parameters. The MAC header 320 may provide information including a source and destination address of the packet, packet type, frame control, duration, sequence control, and quality of service (QoS) control information. The MAC header 320 may also include error checking bits as generated by the MAC 210.

In one embodiment, the MAC header 320 is much longer than the PHY header 310. The transmitter TX 240a of FIG. 2 may transmit the PHY header 310 in a physical (PHY) layer (e.g., also may depicted as a control PHY) which may be used for a beamforming and internal connection at a first MCS 315 in a lower modulation rate than a second MCS 335 in a second modulation rate used for data transmission in the payload 330. In another embodiment, if the MAC header 320 is transmitted at the same modulation rate as the PHY header 310, transmission of the packet 264 may result in long time duration. Another option is to transmit the MAC header 320 in the payload 330. However, since the MAC header 320 may comprise source and destination address of the packet 264, a receiver device such as station 110a or access point 100a may not recognize that the packet 264 was intended for the receiver device.

To overcome these potential issues, the MAC header 320 is coded at an intermediate MCS 325, between the lower modulation rate of the first MCS 315 and the higher modulation rate of the second MCS 335. For example, if transmitting the PHY header 310 at the first MCS 315 with BPSK modulation and a coding rate of ½ while transmitting the payload 330 at the second MCS 335 of 64QAM at a coding rate of ¾, it may be preferable to transmit the MAC header 320 at the intermediate MCS 325 with QPSK modulation at a coding rate of ½, though the embodiment is not so limited. The choice of the MAC header 320 intermediate MCS 325 can be a predetermined function of the PHY header 310 first MCS 315 and the payload 330 second MCS 335, or defined in the MAC header 320. It should be understood to one skilled in the art that TX 240a and/or TX240b is configured to transmit the packet (e.g., packet 264 and/or packet 274) according to a single carrier (SC) modulation scheme and/or according to multiple carrier modulation schemes as described. Also, destination identification (ID) information may be inserted in the PHY header 310 to increase the robustness of the wireless transmission of packets 264 and 274.

FIG. 4 is a block diagram of the packet 264 and/or 274 of FIG. 2 with a preamble 405, a PHY header 410, and a MAC header 420 combined with parity bits 425 in a payload 430 in accordance with some embodiments of the invention. Like the packets 264 and 274 of FIG. 3, the MAC header 420 is much longer than the PHY header 410, though the embodiment is not so limited. The transmitter TX 240a may transmit the PHY header 410 at a first MCS 415 in a lower modulation rate than a second MCS 435 in a second modulation rate used for data transmission in the payload 430.

In this embodiment, the MAC header 420 is a portion of the payload 430, but parity bits 425 according to a FEC code is provided to increase a probability that the MAC header 420 will be received. The parity bits 425 may be formed using Reed Solomon and/or Bose-Chaudhuri-Hocquenghem (BCH) codes for the MAC header 420. In an application of this embodiment, the MAC header 420 may be received by a device such as an access point 100a or station 110a even if the payload 430 is lost. In another embodiment, a shortened destination identification or address may also be provided in the PHY header 410 to identify the destination address in the event that the MAC header 420 is lost.

In reference to FIG. 3, selection of the second modulation rate of MCS 335 used for data transmission in the payload 330 will be higher than the first modulation rate of MCS 315 used for transmission of the PHY header 310, while the intermediate modulation rate at the MCS 325 of the MAC header 320 will be somewhere between the modulation rates of the MCS 315 and the MCS 335. Similarly, in reference to FIG. 4, selection of the second modulation rate of MCS 435 used for data transmission in the payload 430 will be higher than the first modulation rate of MCS 415 used for transmission of the PHY header 410. Adding FEC parity bits 425 formed using a code such as Reed Solomon and/or Bose-Chaudhuri-Hocquenghem (BCH) codes to the MAC header 420 provides a more robust transfer of the packet 274 and payload 430 when inserting the MAC header 420 in the payload 430. Optionally, error checking bits for the MAC header 420 are provided to increase robustness of the wireless communications.

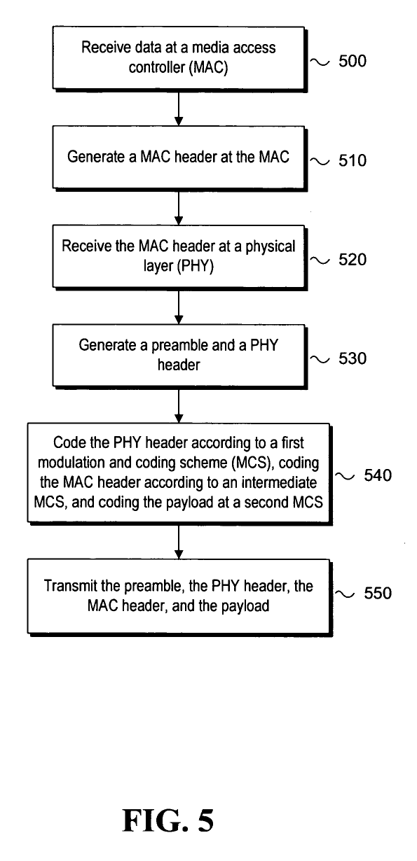

FIG. 5 is a flow diagram of a method to increase robustness of a wireless communication in accordance with some embodiments of the invention. In element 500, data is received at a MAC 210 and a MAC header 320 is generated in element 510. The MAC 210 may be embodied in hardware, software, or some combination thereof. The MAC header 320 may provide information including a source and destination address of the packet, packet type, frame control, duration, sequence control, and quality of service (QoS) control information. In element 520, the MAC header 320 is received at a physical layer (PHY) and a preamble 305 and a PHY header 310 are generated in element 530. The PHY may be embodied in hardware, software, or some combination thereof. The PHY header 310 is coded according to a first MCS 315, the MAC header 320 is coded according to an intermediate MCS 325, and the payload 330 is coded according to the second MCS 335 in element 540. The preamble 305, the PHY header 310, the MAC header 320, and the payload 330 is transmitted by the transceiver array 230 in element 550.

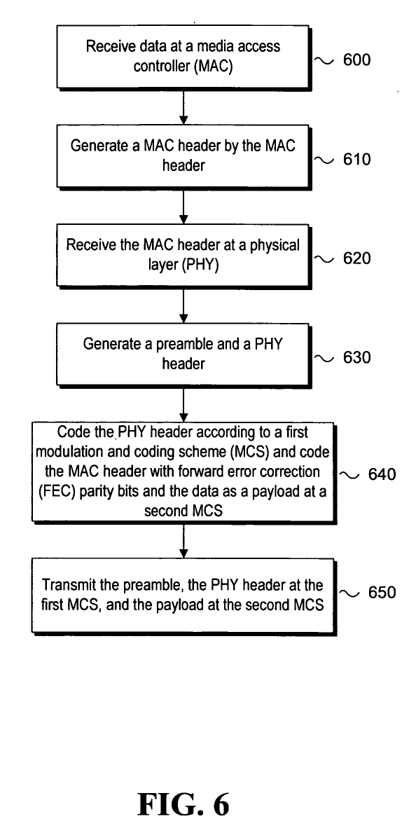

FIG. 6 is an alternate flow diagram of a method to increase robustness of a wireless communication in accordance with some embodiments of the invention. In element 600, data is received at a MAC 210 and a MAC header 420 is generated in element 610. The MAC 210 may be embodied in hardware, software, or some combination thereof. In element 620, the MAC header 420 is received at a physical layer (PHY) and a preamble 405 and a PHY header 410 are generated in element 630. Like the MAC 210, the PHY may also be embodied in hardware, software, or some combination thereof. The PHY header 410 is coded according to a first MCS 415 while the MAC header 420 with forward error correction (FEC) parity bits 425 and data is coded as the payload 430 at the second MCS 435 in element 640. The preamble 405 is transmitted by the transceiver array 230 along with the PHY header 410 at the first MCS 415 and the payload at the second MCS 435 in element 650.

Embodiments may be described herein with reference to data such as instructions, functions, procedures, data structures, application programs, configuration settings, etc. For purposes of this disclosure, the term “program” covers a broad range of software components and constructs, including applications, drivers, processes, routines, methods, modules, and subprograms. The term “program” can be used to refer to a complete compilation unit (i.e., a set of instructions that can be compiled independently), a collection of compilation units, or a portion of a compilation unit. Thus, the term “program” may be used to refer to any collection of instructions which, when executed by the network 140, provides increased MAC header 320, 420 protection. The programs in the network 140 may be considered components of a software environment.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method of transmitting a packet, comprising
receiving data at a media access controller (MAC) to generate a MAC header;
generating the MAC header by the MAC;
receiving the MAC header at a physical layer (PHY);
generating a preamble and a PHY header by the PHY;
coding the PHY header according to a first modulation and coding scheme (MCS), coding the MAC header according to an intermediate MCS, and coding the data as a payload at a second MCS; and
transmitting the preamble, the PHY header at the first MCS, the MAC header at the intermediate MCS, and the payload at the second MCS.

2. The method of claim 1, further including generating error checking bits for the MAC header.

3. The method of claim 2, further including transmitting the error checking bits with the MAC header at the intermediate MCS.

4. The method of claim 1, further including destination identification (ID) information in the PHY header.

5. The method of claim 1, wherein the second MCS includes a higher modulation rate than a modulation rate of the intermediate MCS and a modulation rate of the first MCS.

6. The method of claim 5, wherein the intermediate MCS includes a higher modulation rate than the modulation rate of the first MCS.

7. The method of claim 6, wherein the first MCS is Binary Phase Shift Keying (BPSK) modulation at a coding rate of ½, the second MCS is 64 Quadrature Amplitude Modulation (QAM) at a coding rate of ¾, and the intermediate MCS is Quadrature Phase-Shift Keying (QPSK) modulation at a coding rate of ½.

8. A method of providing header protection in a packet, comprising:
receiving data at a media access controller (MAC);
generating a MAC header by the MAC;
receiving the MAC header at a physical layer (PHY);
generating a preamble and a PHY header;
coding the PHY header according to a first modulation and coding scheme (MCS) and coding the MAC header with forward error correction parity bits and the data as a payload at a second MCS; and
transmitting the preamble, the PHY header at the first MCS, and the payload at the second MCS.

9. The method of claim 8, further including generating error checking bits for the MAC header.

10. The method of claim 9, further including transmitting the error checking bits, the MAC header and the parity bits in the payload at the second MCS.

11. The method of claim 8, further including inserting destination identification (ID) information in the PHY header.

12. The method of claim 8, wherein the first MCS and the second MCS modulation is selected from the group consisting of Binary Phase Shift Keying (BPSK), Quadrature Phase-Shift Keying (QPSK), Quadrature Amplitude Modulation (QAM), 16-QAM, and 64-QAM.

13. The method of claim 8, wherein forward error correction is coded using low-density parity check (LDPC).

14. The method of claim 8, wherein the parity bits are formed using Reed Solomon and/or Bose-Chaudhuri-Hocquenghem (BCH).

15. An apparatus comprising:
a media access controller (MAC) to receive data and to generate a MAC header;
a physical layer (PHY) to receive the MAC header and to generate a preamble and a PHY header, wherein the PHY header is coded according to a first modulation and coding scheme (MCS), the MAC header is coded according to an intermediate MCS, and the data is coded as a payload at a second MCS;
a transceiver array to transmit the preamble, the PHY header at the first MCS, the MAC header at the intermediate MCS, and the payload at the second MCS.

16. The apparatus of claim 15, wherein the MAC is embodied through a software routine.

17. The apparatus of claim 15, wherein the PHY is embodied through a software routine.

18. The apparatus of claim 15, wherein the MAC is configured to generate error checking bits for the MAC header.

19. The apparatus of claim 18, wherein the error checking bits are transmitted by the transceiver array with the MAC header at the intermediate MCS.

20. The apparatus of claim 15, wherein the PHY is configured to insert destination identification (ID) information in the PHY header.
